(19) United States
(12) Patent Application Publication
(10) Pub. No.: US 2021/0101106 A1
(43) Pub. Date: Apr. 8, 2021

(54) Air Purification Device

(71) Applicants: Clarence Clement, Raceland, LA (US); Erica Clement, Raceland, LA (US)

(72) Inventors: Clarence Clement, Raceland, LA (US); Erica Clement, Raceland, LA (US)

(21) Appl. No.: 16/591,775

(22) Filed: Oct. 3, 2019

(51) Int. Cl. B01D 53/04; E03D 9/052

(52) U.S. Cl. CPC B01D 53/0446; E03D 9/052; B01D 2257/90; B01D 2253/106; B01D 2253/108; B01D 2253/102

(57) ABSTRACT

An air purification device for maintaining a clean smelling bathroom includes a housing that defines an interior space. A coupler that is coupled to the housing is configured to selectively couple to a tank of a toilet to couple the housing to the tank. A pump and a filter are coupled to the housing and are positioned in the interior space. An opening that is positioned in the housing is configured to vent the interior space. A tube is coupled to and extends from the housing to a bowl of the toilet. The pump is configured to draw air from the bowl through the tube. The filter is configured to absorb malodorous compounds in the air to purify the air to maintain a clean smell in proximity to the toilet.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to purification devices and more particularly pertains to a new purification device for maintaining a clean smelling bathroom.

### (2) Description of Related Art Including Information Disclosed Under 37 CFR 1.97 and 1.98

The prior art relates to purification devices.

### BRIEF SUMMARY OF THE INVENTION

An embodiment of the disclosure meets the needs presented above by generally comprising a housing that defines an interior space. A coupler that is coupled to the housing is configured to selectively couple to a tank of a toilet to couple the housing to the tank. A pump and a filter are coupled to the housing and are positioned in the interior space. An opening that is positioned in the housing is configured to vent the interior space. A tube is coupled to and extends from the housing to a bowl of the toilet. The pump is configured to draw air from the bowl through the tube. The filter is configured to absorb malodorous compounds in the air to purify the air to maintain a clean smell in proximity to the toilet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an air purification device according to an embodiment of the disclosure.

FIG. 2 is a bottom view of an embodiment of the disclosure.

FIG. 3 is a top view of an embodiment of the disclosure.

FIG. 4 is a side view of an embodiment of the disclosure.

### DETAILED DESCRIPTION OF THE INVENTION

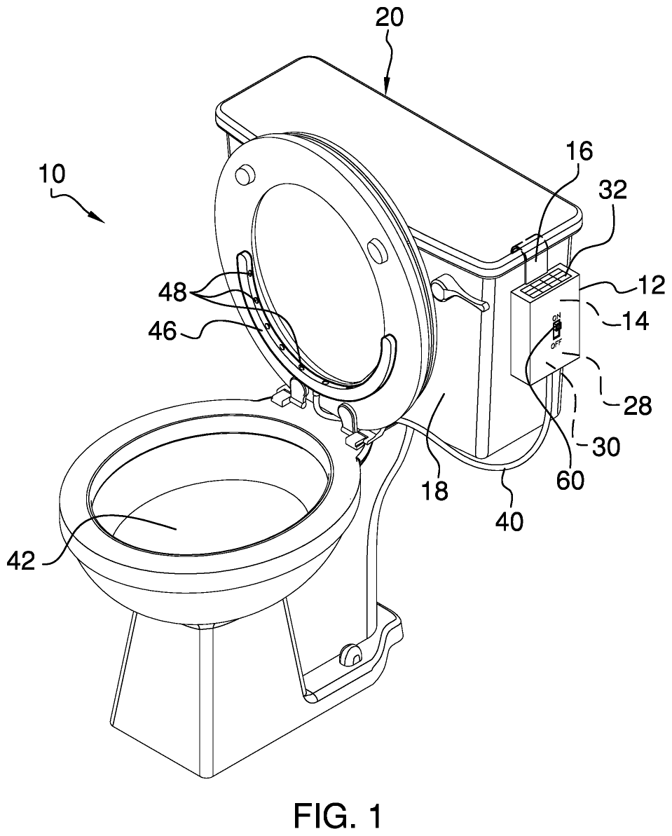

With reference now to the drawings, and in particular to FIGS. 1 through 4 thereof, a new purification device embodying the principles and concepts of an embodiment of the disclosure and generally designated by the reference numeral 10 will be described.

As best illustrated in FIGS. 1 through 4, the air purification device 10 generally comprises a housing 12 that defines an interior space 14. The housing 12 may be substantially rectangularly box shaped, or may be alternatively shaped, such as, but not limited to, tubularly shaped, disc shaped, and the like.

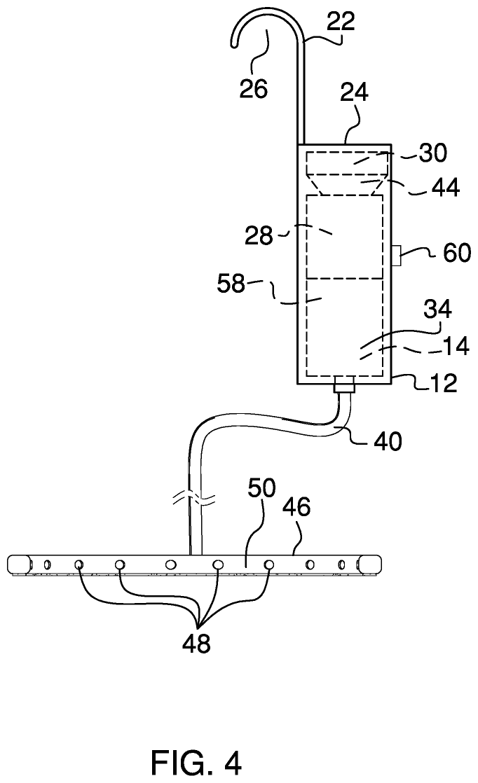

A coupler 16 that is coupled to the housing 12 is configured to selectively couple to a tank 18 of a toilet 20 to couple the housing 12 to the tank 18. The coupler 16 may comprise a hook 22 that is coupled to and extends from a top 24 of the housing 12, as shown in FIG. 4. A gap 26 of the hook 22 is configured to insert a rim of a wall of the tank 18 so that the housing 12 is suspended from the tank 18. The coupler 16 also may comprise other coupling means, such as, but not limited to, adhesives, suction cups, and the like.

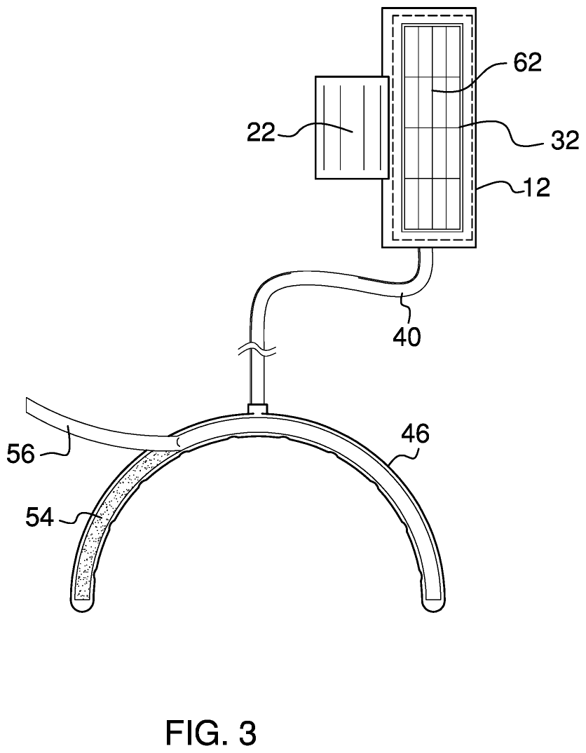

A pump 28 and a filter 30 are coupled to the housing 12 and are positioned in the interior space 14. An opening 32 that is positioned in the housing 12 is configured to vent the interior space 14. The opening 32 may be positioned in the top 24 of the housing 12, as shown in FIG. 3, or may be positioned in a side 34, bottom 36, or front 38 of the housing 12. The opening 32 may be rectangularly shaped, or may be alternatively shaped, such as, but not limited to, ovally shaped, circularly shaped, and the like.

A tube 40 is coupled to and extends from the housing 12 to a bowl 42 of the toilet 20, as shown in FIG. 1. The pump 28 is configured to draw air from the bowl 42 through the tube 40. The filter 30 is configured to absorb malodorous compounds in the air to purify the air. The filter 30 comprises at least one of activated charcoal, silica, and zeolite so that the filter 30 is configured to absorb the malodorous compounds in the air to purify the air.

The filter 30 is permeated with an aroma compound 44 so that the filter 30 is configured to release the aroma compound 44 into the air that passes through the filter 30 to freshen the air.

The filter 30 may be positioned between the pump 28 and the opening 32, as shown in FIG. 4, so that the air is pushed through the filter 30. The filter 30 also may be positioned between the pump 28 and the tube 40 (not shown) so that the air is drawn through the filter 30.

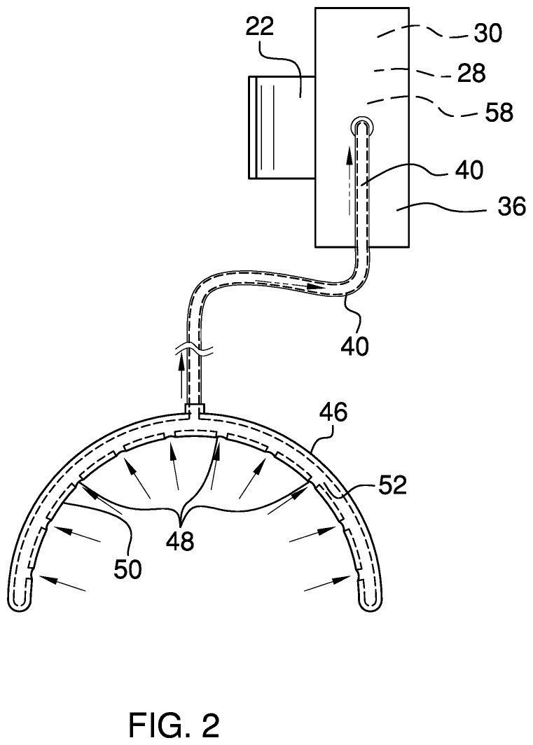

A pipe 46 is coupled to and extends bidirectionally from the tube 40 distally from the pump 28, as shown in FIG. 2. The pipe 46 is arcuate so that the pipe 46 is shaped complementarily to a curvature of a seat of the toilet 20. A plurality of apertures 48 that is positioned in an inner perimeter 50 of the pipe 46 is configured for entry of air from the bowl 42 of the toilet 20 into the pipe 46.

A fastener 52 that is coupled to the pipe 46 is configured to selectively couple to the seat of the toilet 20 to couple the pipe 46 to the seat of the toilet 20. Alternatively, the fastener 52 can be used to couple the pipe 46 to a lip of the bowl 42. The fastener 52 may comprise an adhesive 54, as shown in FIG. 3, or other fastening means, such as, but not limited to, hook and loop fasteners, clips, and the like. A strip 56 that is selectively couplable to the adhesive 54 is configured to prevent inadvertent adhesion of the adhesive 54. The strip 56 is configured to be decoupled from the adhesive 54, positioning the adhesive 54 to couple the pipe 46 to the seat of the toilet 20.

A battery 58 is coupled to the housing 12 and is positioned in the interior space 14. The battery 58 is operationally coupled to the pump 28 so that the battery 58 is positioned to selectively power the pump 28.

A switch 60 that is coupled to the housing 12 is operationally coupled to the battery 58 and the pump 28. The switch 60 is configured to be switched to selectively couple the pump 28 to the battery 58. The switch 60 may be slide-switch type, as shown in FIG. 4, or may be other type, such as, but not limited to, toggle type, push button type, and the like.

A grate 62 is selectively couplable to the housing 12 to screen the opening 32, as shown in FIG. 3. The grate 62 is configured to be removed from the housing 12 to access the interior space 14 to service the pump 28, the filter 30, and the battery 58.

In use, a user simply switches the switch 60 upon entering the bathroom to use the toilet 20. The pump 28 draws the air from the bowl 42 and pushes the air through the filter 30, which absorbs the malodorous compounds in the air and releases the aroma compound 44 so that the air is both purified and freshened before exiting the housing 12 through the opening 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. An air purification device comprising:
a housing defining an interior space;
a coupler coupled to the housing, the coupler being configured for selectively coupling to a tank of a toilet wherein the coupler is configured for coupling the housing to the tank;
a pump coupled to the housing and positioned in the interior space;
an opening positioned in the housing wherein the opening is configured for venting the interior space;
a filter coupled to the housing and positioned in the interior space; and
a tube coupled to and extending from the housing to a bowl of the toilet wherein the pump is configured for drawing air from the bowl through the tube wherein the filter is configured for absorbing malodorous compounds in the air for purifying the air.

2. The device of claim 1, further including the coupler comprising a hook coupled to and extending from a top of the housing wherein a gap of the hook is configured for inserting a rim of a wall of the tank such that the housing is suspended from the tank.

3. The device of claim 1, further including the opening being positioned in a top of the housing.

4. The device of claim 1, further comprising:
the housing being substantially rectangularly box shaped; and
the opening being rectangularly shaped.

5. The device of claim 1, further including the filter being positioned between the pump and the opening.

6. The device of claim 1, further including the filter comprising at least one of activated charcoal, silica, and zeolite wherein the filter is configured for absorbing the malodorous compounds in the air for purifying the air.

7. The device of claim 1, further including the filter being permeated with an aroma compound wherein the filter is configured for releasing the aroma compound into the air passing through the filter for freshening the air.

8. The device of claim 1, further comprising:
a pipe coupled to and extending bidirectionally from the tube distal from the pump, the pipe being arcuate such that the pipe is shaped complementarily to a curvature of a seat of the toilet;
a fastener coupled to the pipe, the fastener being configured for selectively coupling to the seat of the toilet wherein the fastener is configured for coupling the pipe to the seat of the toilet; and
a plurality of apertures positioned in an inner perimeter of the pipe wherein the apertures are configured for entering of air from the bowl of the toilet into the pipe.

9. The device of claim 8, further comprising:
the fastener comprising an adhesive; and
a strip selectively couplable to the adhesive wherein the strip is configured for preventing inadvertent adhesion of the adhesive and for being decoupled from the adhesive positioning the adhesive for coupling the pipe to the seat of the toilet.

10. The device of claim 1, further comprising:
a battery coupled to the housing and positioned in the interior space, the battery being operationally coupled to the pump such that the battery is positioned for selectively powering the pump; and
a switch coupled to the housing, the switch being operationally coupled to the battery and the pump wherein the switch is configured for being switched for selectively coupling the pump to the battery.

11. The device of claim 10, further including the switch being slide-switch type.

12. The device of claim 10, further including a grate selectively couplable to the housing for screening the opening wherein the grate is configured for being removed from the housing for accessing the interior space for servicing the pump, the filter, and the battery.

13. A toilet and air purification device combination comprising:
a toilet;
a housing defining an interior space;
a coupler coupled to the housing, the coupler being configured for selectively coupling to a tank of the toilet wherein the coupler is configured for coupling the housing to the tank;
a pump coupled to the housing and positioned in the interior space;
an opening positioned in the housing wherein the opening is configured for venting the interior space;
a filter coupled to the housing and positioned in the interior space; and
a tube coupled to and extending from the housing to a bowl of the toilet wherein the pump is configured for drawing air from the bowl through the tube wherein the filter is configured for absorbing malodorous compounds in the air for purifying the air.

14. An air purification device comprising:
a housing defining an interior space, the housing being substantially rectangularly box shaped;
a coupler coupled to the housing, the coupler being configured for selectively coupling to a tank of a toilet wherein the coupler is configured for coupling the housing to the tank, the coupler comprising a hook coupled to and extending from a top of the housing wherein a gap of the hook is configured for inserting a rim of a wall of the tank such that the housing is suspended from the tank;
a pump coupled to the housing and positioned in the interior space;
an opening positioned in the housing wherein the opening is configured for venting the interior space, the opening being positioned in the top of the housing, the opening being rectangularly shaped;
a filter coupled to the housing and positioned in the interior space, the filter being positioned between the pump and the opening, the filter being permeated with an aroma compound;
a tube coupled to and extending from the housing to a bowl of the toilet wherein the pump is configured for drawing air from the bowl through the tube wherein the filter is configured for absorbing malodorous compounds in the air for purifying the air and for releasing the aroma compound into the air passing through the filter for freshening the air;
a pipe coupled to and extending bidirectionally from the tube distal from the pump, the pipe being arcuate such that the pipe is shaped complementarily to a curvature of a seat of the toilet;
a fastener coupled to the pipe, the fastener being configured for selectively coupling to the seat of the toilet wherein the fastener is configured for coupling the pipe to the seat of the toilet, the fastener comprising an adhesive;
a strip selectively couplable to the adhesive wherein the strip is configured for preventing inadvertent adhesion of the adhesive and for being decoupled from the adhesive positioning the adhesive for coupling the pipe to the seat of the toilet;
a plurality of apertures positioned in an inner perimeter of the pipe wherein the apertures are configured for entering of air from the bowl of the toilet into the pipe;
a battery coupled to the housing and positioned in the interior space, the battery being operationally coupled to the pump such that the battery is positioned for selectively powering the pump;
a switch coupled to the housing, the switch being operationally coupled to the battery and the pump wherein the switch is configured for being switched for selectively coupling the pump to the battery, the switch being slide-switch type; and
a grate selectively couplable to the housing for screening the opening wherein the grate is configured for being removed from the housing for accessing the interior space for servicing the pump, the filter, and the battery.
